(19) United States
(12) Patent Application Publication
(10) Pub. No.: US 2014/0194155 A1
(43) Pub. Date: Jul. 10, 2014

(54) DYNAMICALLY SELECTING FILTERING PATHS TO AVOID MULTI-RADIO COEXISTENCE INTERFERENCE IN A COMMUNICATION APPARATUS

(71) Applicant: MediaTek Inc., Hsin-Chu (TW)

(72) Inventors: Li-Chun KO, Taipei City (TW); Chun-Jen TSAI, Shanhua Township (TW); Chia-Hsiang HSU, Kaohsiung City (TW); Hao-Hua KANG, Taoyuan City (TW); Tzu-Wei HAN, New Taipei City (TW); Yu-Ching LIU, New Taipei City (TW); Hsiao-Min CHEN, Taichung City (TW); Jian-Hsiung LIAO, Zhudong Township (TW)

(73) Assignee: MediaTek Inc., Hsin-Chu (TW)

(21) Appl. No.: 14/068,412

(22) Filed: Oct. 31, 2013

Related U.S. Application Data
(60) Provisional application No. 61/748,841, filed on Jan. 4, 2013.

(51) Int. Cl. H04B 1/40

(52) U.S. Cl. CPC H04B 1/406
USPC 455/552.1

(57) ABSTRACT

A communication apparatus includes a first wireless module and a second wireless module. The first wireless module includes a communication device, an antenna module and a filter module. The filter module is coupled between the communication device and the antenna module and includes a first filter, a second filter, a first switch switching in response to a control signal, and a second switch switching in response to the control signal. The communication device includes a processor issuing the control signal according to a radio frequency utilized by the second wireless module to select the first filter or the second filter to electronically connect to the communication device and the antenna module.

### CROSS REFERENCE TO RELATED APPLICATIONS

This application claims the benefit of U.S. Provisional Application No. 61/748,841 filed Jan. 4, 2013 and entitled “Dynamic Selection of Split Filters for Multi-Radio Coexistence”. The entire contents of which are hereby incorporated by reference.

### BACKGROUND OF THE INVENTION

1. Field of the Invention

The invention relates to a multi-radio communication apparatus capable of providing multi-radio access technology (RAT) communication, and more particularly to a multi-radio communication apparatus capable of providing multi-RAT communication and dynamically selecting filtering paths to avoid multi-radio coexistence interference.

2. Description of the Related Art

With the development of wireless communications technology, mobile electronic devices may be provided with more than one wireless communications service, such as Bluetooth, Wireless Fidelity (WiFi), Long Term Evolution (LTE) wireless communications service, and so on. In this regard, the overlapping or adjacent operating frequency bands among the different wireless communications services causes the transmission and reception performance thereof to degrade.

Therefore, a multi-radio communication apparatus capable of providing multi-RAT communication and avoiding multi-radio coexistence interference is required.

### BRIEF SUMMARY OF THE INVENTION

Communication apparatuses are provided. An exemplary embodiment of a communication apparatus comprises a first wireless module and a second wireless module. The first wireless module comprises a communication device, an antenna module and a filter module. The communication device comprises a processor and is capable of providing a first wireless communication service of a first radio access technology (RAT) in compliance with a first protocol. The filter module is coupled between the communication device and the antenna module and comprises a first filter, a second filter, a first switch switching in response to a control signal, and a second switch switching in response to the control signal. The processor issues the control signal according to a radio frequency utilized by the second wireless module to select the first filter or the second filter to electronically connect to the communication device and the antenna module.

An exemplary embodiment of a communication apparatus comprises a first wireless module capable of utilizing a first radio frequency to provide a first wireless communication service of a first radio access technology (RAT), a second wireless module capable of utilizing a second radio frequency to provide a second wireless communication service of a second RAT and a processor. The first wireless module comprises a communication device, an antenna module and a filter module. The communication device provides the first wireless communication service of the first RAT in compliance with a first protocol. The processor issues the control signal to select the first filter or the second filter to electronically connect to the communication device and the antenna module according to the first radio frequency and the second radio frequency, and a first frequency range of a first passband of the first filter overlaps a second frequency range of a second passband of the second filter.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a block diagram of a communication apparatus according to an embodiment of the invention;

FIG. 2 shows an exemplary block diagram of the filter module according to an embodiment of the invention;

FIG. 3 is an exemplary timing diagram showing dynamic selections of different filtering paths according to an embodiment of the invention;

FIG. 4 is an exemplary timing diagram showing the scheduling of radio activities according to an embodiment of the invention;

FIG. 5 is an exemplary timing diagram showing dynamic selections of different filtering paths according to an embodiment of the invention;

FIG. 6 is an exemplary timing diagram showing the scheduling of radio activities according to an embodiment of the invention;

FIG. 7 is an exemplary timing diagram showing dynamic selections of different filtering paths according to an embodiment of the invention;

FIG. 8 is an exemplary timing diagram showing the scheduling of radio activities according to an embodiment of the invention;

FIG. 9A and FIG. 9B show a flow chart of a method for dynamically selecting one of the filtering paths for the wireless module 120 according to an embodiment of the invention; and

FIG. 10 shows a flow chart of a method for determining the duplex mode between different wireless modules according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

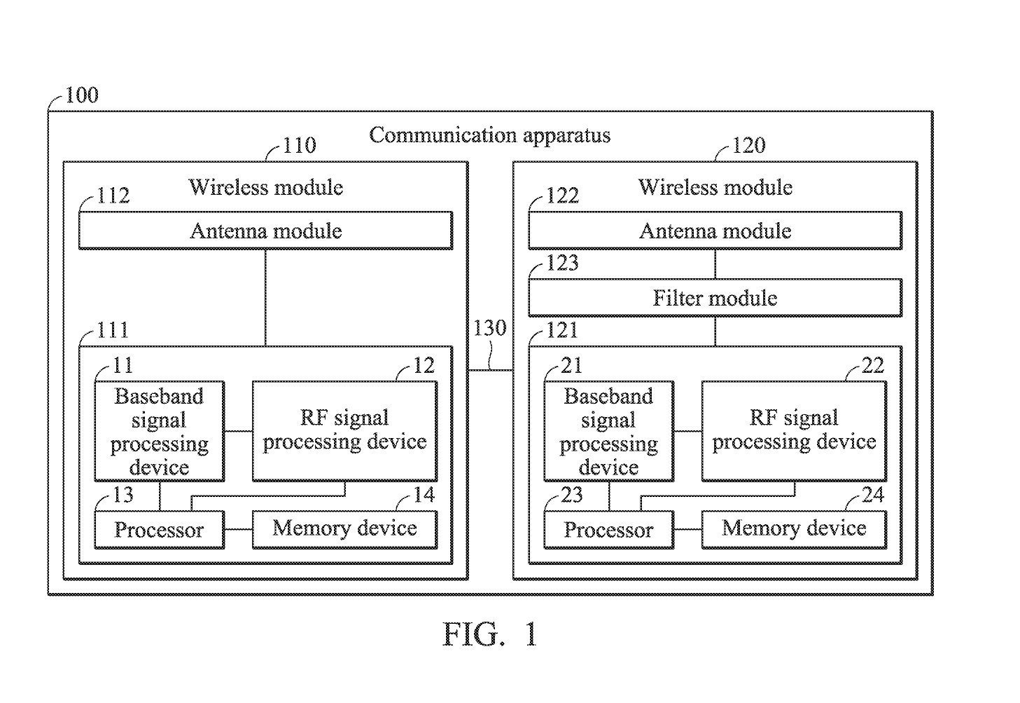

FIG. 1 shows a block diagram of a communication apparatus according to an embodiment of the invention. The communication apparatus 100 may be a notebook, a cellular phone, a portable gaming device, a portable multimedia player, a Global Positioning System (GPS), a receiver, a personal digital assistant, a tablet computer, or the like. The communication apparatus 100 may comprise wireless modules 110 and 120 capable of providing wireless communication services based on different radio access technologies (RATs). For example, according to an embodiment of the invention, the wireless module 110 may be an LTE module capable of providing LTE wireless communication services in compliance with LTE protocols and the wireless module 120 may be a WiFi module capable of providing WiFi wireless communication services in compliance with WiFi protocols, a Bluetooth module capable of providing Bluetooth wireless communication services in compliance with Bluetooth protocols, or a WiFi and Bluetooth combo module capable of providing WiFi and Bluetooth wireless communication services in compliance with both the WiFi and Bluetooth protocols. In addition, the communication apparatus 100 may further comprise an interface 130 and the wireless modules 110 and 120 may communicate with each other via the interface 130.

The wireless module 110 may comprise a communication device 111 and an antenna module 112. The communication device 111 may comprise a baseband signal processing device 11, a radio frequency (RF) signal processing device 12, a processor 13 and a memory device 14. The antenna module 112 may comprise at least one antenna. The RF signal processing device 12 may receive RF signals via the antenna, and process the received RF signals to convert the received RF signals to baseband signals to be processed by the baseband signal processing device 11, or receive baseband signals from the baseband signal processing device 11 and convert the received baseband signals to RF signals to be transmitted to a peer communication apparatus. The RF signal processing device 12 may comprise a plurality of hardware elements to perform radio frequency conversion. For example, the RF signal processing device 12 may comprise a mixer to multiply the baseband signals with a carrier oscillated in the radio frequency utilized by the wireless module.

The baseband signal processing device 11 may further process the baseband signals to convert the baseband signals to a plurality of digital signals, and process the digital signals, and vice versa. The baseband signal processing device 11 may also comprise a plurality of hardware elements to perform baseband signal processing. The baseband signal processing may comprise analog-to-digital conversion (ADC)/digital-to-analog conversion (DAC), gain adjustment, modulation/demodulation, encoding/decoding, and so on. The processor 13 may control the operations of the baseband signal processing device 11, the RF signal processing device 12 and the memory device 14 which may store the system data and program codes of the communication device 111. According to an embodiment of the invention, the processor 13 may be arranged to execute the program codes of the corresponding software module(s) of the baseband signal processing device 11 and/or the RF signal processing device 12. Note that in some embodiments of the invention, the processor 13 may also be integrated in the baseband signal processing device 11 and the invention should not be limited thereto.

The wireless module 120 may comprise a communication device 121, an antenna module 122 and a filter module 123. The communication device 121 may comprise a baseband signal processing device 21, a radio frequency (RF) signal processing device 22, a processor 23 and a memory device 24. The antenna module 122 may comprise at least one antenna. The operations of the baseband signal processing device 21, the RF signal processing device 22, the processor 23 and the memory device 24 of the communication device 121 are similar to those of the baseband signal processing device 11, the RF signal processing device 12, the processor 13 and the memory device 14 of the communication device 111. For the sake of brevity, reference may be made to the descriptions of the corresponding elements in the communication device 111 as discussed above, and details are omitted here for brevity.

In addition, since the wireless module 120 may be a combo wireless module, such as the WiFi and Bluetooth combo module as discussed above, the communication device 121 may be implemented by a combo chip capable of providing wireless communication functionalities of both RATs, or be implemented by multiple chips, and the invention should not be limited thereto. Note further that although the LTE, WiFi and Bluetooth RATs are illustrated above and hereinafter as preferred embodiments, the invention should not be limited thereto. The proposed architecture and selecting methods will be illustrated further below and may also be applied to any other RATs that operate in adjacent or overlapped radio frequencies.

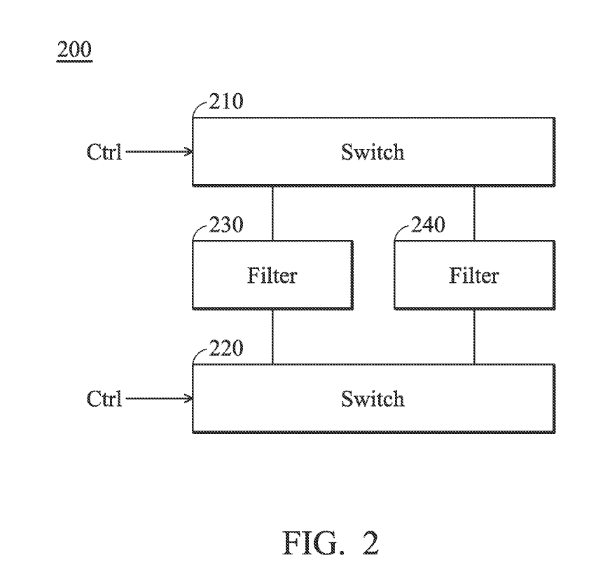

FIG. 2 shows an exemplary block diagram of the filter module according to an embodiment of the invention. The filter module 200 may comprise two switches 210 and 220 and two filters 230 and 240. The filters 230 and 240 may contribute two filtering paths between the communication device 121 and the antenna module 122, and the switches 210 and 220 switch in response to a control signal Ctrl for dynamically selecting one of the filtering paths for filtering the RF signals received from the antenna module 122 or the communication device 121. The switches 210 and 220 may be single pole double throw (SPDT) switches. According to an embodiment of the invention, the control signal Ctrl is a real-time control signal and may be issued by the processor 13, processor 23, or a dedicated arbiter (not shown) comprised in the communication apparatus 100. Note that the arbiter may be also regarded as a processor and may be configured outside of the wireless modules 110 and 120 or integrated in either wireless module 110 or 120.

The filter 230 (hereinafter called the first filter A) may be designed to have a first passband in a first frequency range, and the filter 230 (hereinafter called the second filter B) may be designed to have a second passband in a second frequency range. Note that as known in the art, the frequency range of a passband may be defined by the frequencies having −3 dB attenuation.

According to a first embodiment of the invention, the first frequency range is located in a lower portion of a predetermined frequency range and the second frequency range is located in an upper portion of the predetermined frequency range, and the first frequency range may partially overlap the second frequency range. According to an embodiment of the invention, a union of the first frequency range and the second frequency range may cover the predetermined frequency range, and the predetermined frequency range may be, for example, from 2.4 GHz to 2.5 GHz. For example, the first passband of the first filter A may be designed to cover from 2400 MHz to 2472 MHz, and the second passband of the second filter B may be designed to cover from 2432 MHz to 2500 MHz.

According to a second embodiment of the invention, the first frequency range may completely overlap the second frequency range and may be narrower than the second frequency range. For example, the first passband of the first filter A may be designed to cover from 2420 MHz to 2472 MHz, and the second passband of the second filter B may be designed to cover from 2400 MHz to 2500 MHz.

According to an embodiment of the invention, the processor (the processor 13, 23 or a dedicated arbiter as discussed above) may issue the control signal Ctrl according to a radio frequency utilized by the wireless module 110 to select the first filter A or the second filter B to electronically connect to the communication device 121 and the antenna module 122 of the wireless module 120. For example, when the radio frequency utilized by the wireless module 110 falls in the first frequency range of the first passband of the first filter A in the first embodiment of the invention, the processor may select the second filter B to electronically connect to the communication device 121 and the antenna module 122.

According to another embodiment of the invention, the processor (i.e. the processor 13, 23 or a dedicated arbiter as discussed above) may issue the control signal Ctrl according to a radio frequency utilized by the wireless module 110 and a radio frequency utilized by the wireless module 120 to select the first filter A or the second filter B to electronically connect to the communication device 121 and the antenna module 122 of the wireless module 120. For example, the radio frequency utilized by the wireless module 110 and the radio frequency utilized by the wireless module 120 both fall in the first frequency range of the first passband of the first filter A in the first or second embodiment of the invention, and the processor may select the first filter A to electronically connect to the communication device 121 and the antenna module 122.

Considering cases in which the wireless module 110 is an LTE module and the wireless module 120 is a WiFi and Bluetooth combo module, information regarding the radio frequency utilized by the wireless module 110 may be obtained during the process for the wireless module 110 to establish an LTE connection with a peer communication apparatus. The information may be provided to the wireless module 120 via the interface 130 when required. Similarly, information regarding the radio frequency utilized by the wireless module 120 for a WiFi communication may be obtained during the process when the wireless module 120 establishes a WiFi connection with a peer communication apparatus. Information regarding the radio frequency utilized by the wireless module 120 for a Bluetooth communication may be obtained by the wireless module 120 itself when the wireless module 120 operates as a Bluetooth master device and may be obtained from a peer master device when the wireless module 120 operates as a slave device. The information regarding the radio frequencies utilized by the wireless module 120 may also be provided to the wireless module 110 via the interface 130 when required.

Note that in other embodiments of the invention, the switches 210 and 220 are not limited to be single pole double throw (SPDT) switches, and may be single pole triple throw (SP3T) switches, or single pole multiple throw (SPXT) switches, where X is an integer greater than 3. For example, when the wireless module 120 is a WiFi module or a WiFi and Bluetooth combo module capable of supporting 2.4 GHz and 5 GHz WiFi communication services, the filter module 200 may comprise two SP3T switches and three filters coupled in parallel between two SP3T switches, where two of the filters may be designed to collaboratively cover a frequency band from 2.4 GHz to 2.5 GHz as discussed above, and one on the filters may be designed to cover a frequency band around 5 GHz. Note that in some embodiments, the 5 GHz filter may also be replaced by a dedicated transmission line for directly by passing the 5 GHz RF signals, and the invention should not be limited thereto.

In the following paragraphs, several scenarios are introduced to further illustrate the methods for dynamically selecting one of the filtering paths for the wireless module 120. Note that, in the following scenarios, the passband designs for the first filter A and the second filter B in the first embodiment are applied. However, those who are skilled in this technology can easily derive the methods for dynamically selecting one of the filtering paths for the wireless module 120 based on the passband designs as in the second embodiment. Therefore, the invention should not be limited thereto.

Scenario 1: the wireless module 110 uses LTE Band 7, and the wireless module 120 uses WiFi Channel 1 and Bluetooth Channel 1˜Channel 20 for frequency hopping. In this manner, the radio frequency utilized by the wireless module 110 ranges from 2500˜2570 MHz for uplink and ranges from 2620˜2690 MHz for downlink, and the radio frequency utilized by the wireless module 120 ranges from 2401˜2423 MHz for WiFi and ranges from 2402˜2421 MHz for Bluetooth. Since the radio frequency utilized by the wireless module 110 is above 2500 MHz and the radio frequency utilized by the wireless module 120 ranges mainly from 2401˜2423 MHz, the processor (i.e. the processor 13, 23 or a dedicated arbiter as discussed above) may select the first filter A to electronically connect to the antenna module 122 and the communication device 121 for filtering the RF signals received from the antenna module 122 or the communication device 121.

For scenario 1, since enough guard band (for example, over 30 MHz wide) can be provided between the radio frequencies utilized by the wireless modules 110 and 120, there should be no interference between the wireless modules 110 and 120, and the wireless modules 110 and 120 may both be free to perform their radio activities any time in a frequency division multiplex (FDM) manner. Note that, in the application, the “radio activities” may comprise both the transmitting activities and receiving activities. Note further that when one or more hardware devices in the wireless module 120 are shared for performing the WiFi and Bluetooth radio activities, the WiFi and Bluetooth radio activities may also be performed in a time-division multiplex (TDM) manner by the wireless module 120, and the invention should not be limited thereto.

Note further that, in the embodiments of the invention, when the radio activities of two wireless modules or two RATs are performed in the TDM manner, it may cover two cases. The first case is one in which the radio activities of one wireless module or RAT and the radio activities of the other wireless module or RAT are performed at different times in the TDM manner. The second case is one in which the transmitting activities of two wireless modules or two RATs may be performed at the same time. In addition, the receiving activities of two wireless modules or two RATs may be performed at the same time. However, the transmitting activities and the receiving activities are performed at different times in the TDM manner.

Scenario 2: the wireless module 110 uses LTE Band 40, and the wireless module 120 uses WiFi Channel 11 and Bluetooth Channel 59˜Channel 78 for frequency hopping. In this manner, the radio frequency utilized by the wireless module 110 ranges from 2300˜2400 MHz, and the radio frequency utilized by the wireless module 120 ranges from 2451˜2473 MHz for WiFi and ranges from 2460˜2479 MHz for Bluetooth. Since the radio frequency utilized by the wireless module 110 is below 2400 MHz and the radio frequency utilized by the wireless module 120 ranges mainly from 2451˜2479 MHz, the processor (i.e. the processor 13,23 or a dedicated arbiter as discussed above) may select the first filter B to electronically connect to the antenna module 122 and the communication device 121 for filtering the RF signals received from the antenna module 122 or the communication device 121.

For scenario 2, since enough guard band (for example, over 30 MHz wide) can be provided between the radio frequencies utilized by the wireless modules 110 and 120, there should be no interference between the wireless modules 110 and 120, and the wireless modules 110 and 120 may both be free to perform their radio activities at any time in an FDM manner. Note further that, when one or more hardware devices in the wireless module 120 are shared for performing the WiFi and Bluetooth radio activities, the WiFi and Bluetooth radio activities may also be performed in a TDM manner by the wireless module 120, and the invention should not be limited thereto.

Scenario 3: the wireless module 110 uses LTE Band 40, and the wireless module 120 uses WiFi Channel 11 and Bluetooth Channel 1˜Channel 20 for frequency hopping. In this manner, the radio frequency utilized by the wireless module 110 ranges from 2300˜2400 MHz, and the radio frequency utilized by the wireless module 120 ranges from 2451˜2473 MHz for WiFi and ranges from 2402˜2421 MHz for Bluetooth. Since the radio frequencies utilized by the wireless module 120 to perform the WiFi and Bluetooth are separated from each other and cannot both fall in the first frequency range or the second frequency range, the processor (i.e. the processor 13, 23 or a dedicated arbiter as discussed above) may dynamically select the first filter A or the second filter B to electronically connect to the antenna module 122 and the communication device 121 based on the WiFi and Bluetooth radio activities scheduling. For example, when performing the WiFi radio activities, the processor selects the second filter B and when performing the Bluetooth radio activities, the processor selects the first filter A.

FIG. 3 is an exemplary timing diagram showing dynamic selections of different filtering paths according to an embodiment of the invention. In FIG. 3, path A represents selection of the first filter A and path B represents selection of the second filter B. As shown in FIG. 3, the filtering path is continuously switched between path A and path B. The timing of switching the filtering path may depend on the timing of performing the WiFi and Bluetooth radio activities.

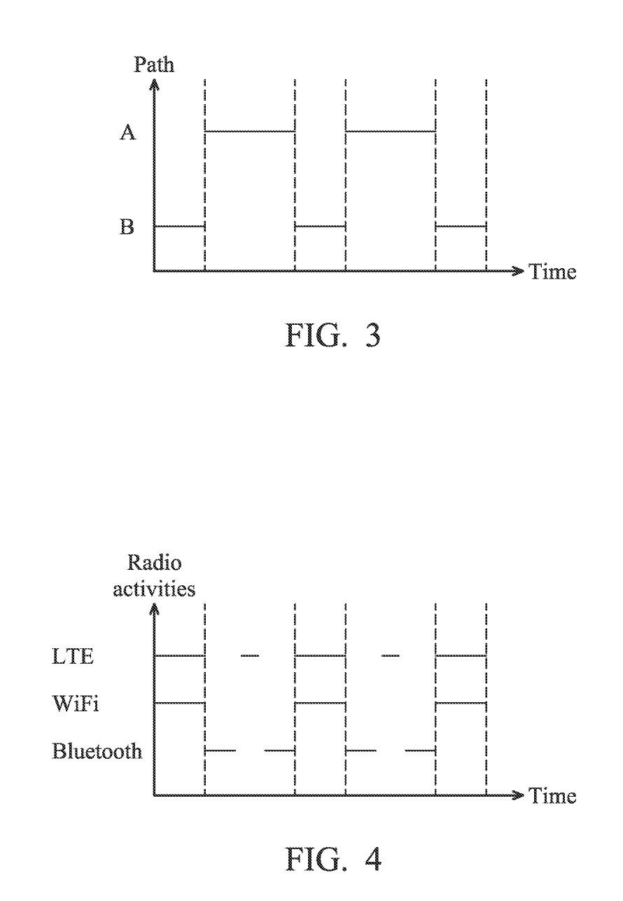

FIG. 4 is an exemplary timing diagram showing the scheduling of radio activities according to an embodiment of the invention, wherein the radio activities shown from the top row to the bottom row are the LTE, WiFi and Bluetooth radio activities, respectively. As shown in FIG. 4, the LTE and WiFi radio activities may be scheduled and/or performed simultaneously in the FDM manner since enough guard band (for example, over 30 MHz wide) can be provided between the radio frequencies utilized by the wireless module 110 for performing the LTE radio activities and by the wireless module 120 for performing the WiFi radio activities. The WiFi and Bluetooth radio activities are scheduled in the TDM manner since the filter path is dynamically switched between path A and path B. In addition, the LTE and Bluetooth radio activities are scheduled in the TDM manner since not enough guard band (for example, over 30 MHz wide) can be provided between the radio frequencies utilized by the wireless module 110 for performing the LTE radio activities and by the wireless module 120 for performing the Bluetooth radio activities.

Scenario 4: the wireless module 110 uses LTE Band 40, and the wireless module 120 uses WiFi Channel 1 and Bluetooth Channel 59˜Channel 78 for frequency hopping. In this manner, the radio frequency utilized by the wireless module 110 ranges from 2300˜2400 MHz, and the radio frequency utilized by the wireless module 120 ranges from 2401˜2423 MHz for WiFi and ranges from 2460˜2479 MHz for Bluetooth. Since the radio frequencies utilized by the wireless module 120 to perform the WiFi and Bluetooth are separated from each other and cannot both fall in the first frequency range or the second frequency range, the processor (i.e. the processor 13, 23 or a dedicated arbiter as discussed above) may dynamically select the first filter A or the second filter B to electronically connect to the antenna module 122 and the communication device 121 based on the WiFi and Bluetooth radio activities scheduling. For example, when performing the WiFi radio activities, the processor selects the first filter A, and when performing the Bluetooth radio activities, the processor selects the second filter B.

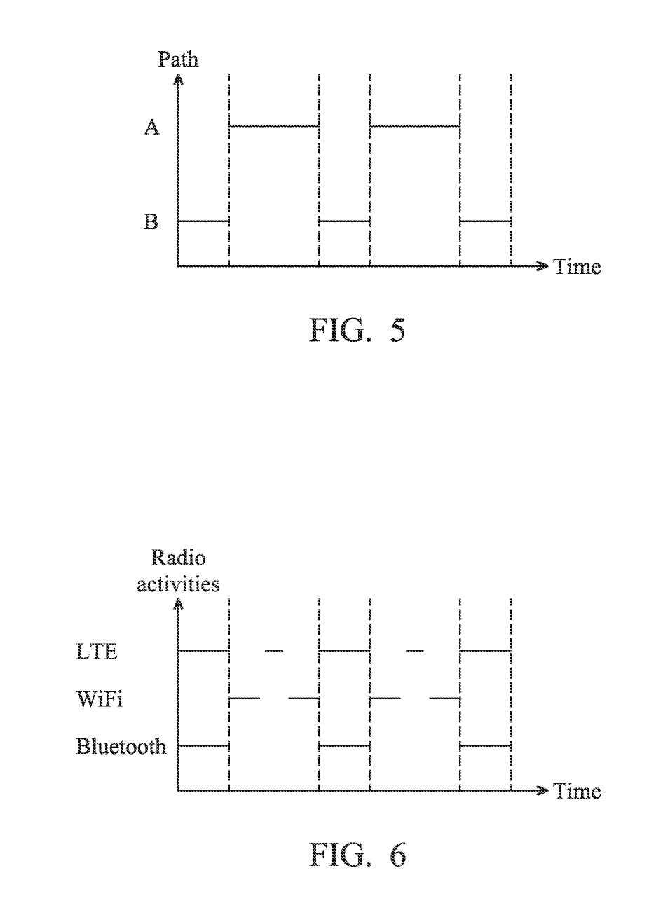

FIG. 5 is an exemplary timing diagram showing dynamic selections of different filtering paths according to an embodiment of the invention. In FIG. 5, path A represents selection of the first filter A and path B represents selection of the second filter B. As shown in FIG. 5, the filtering path is continuously switched between path A and path B. The timing of switching the filtering path may depend on the timing of performing the WiFi and Bluetooth radio activities.

FIG. 6 is an exemplary timing diagram showing the scheduling of radio activities according to an embodiment of the invention, wherein the radio activities shown from the top row to the bottom row are the LTE, WiFi and Bluetooth radio activities, respectively. As shown in FIG. 6, the LTE and Bluetooth radio activities may be scheduled and/or performed simultaneously in the FDM manner since enough guard band (for example, over 30 MHz wide) can be provided between the radio frequencies utilized by the wireless module 110 for performing the LTE radio activities and by the wireless module 120 for performing the Bluetooth radio activities. The WiFi and Bluetooth radio activities are scheduled in the TDM manner since the filter path is dynamically switched between path A and path B. In addition, the LTE and WiFi radio activities are scheduled in the TDM manner since not enough guard band (for example, over 30 MHz wide) can be provided between the radio frequencies utilized by the wireless module 110 for performing the LTE radio activities and by the wireless module 120 for performing the WiFi radio activities.

Scenario 5: the wireless module 110 uses LTE Band 40, and the wireless module 120 uses WiFi Channel 1 and Bluetooth Channel 1˜Channel 20 for frequency hopping. In this manner, the radio frequency utilized by the wireless module 110 ranges from 2300˜2400 MHz, and the radio frequency utilized by the wireless module 120 ranges from 2401˜2423 MHz for WiFi and ranges from 2402˜2421 MHz for Bluetooth. Since the radio frequencies utilized by the wireless modules 110 and 120 all fall in the first frequency range, the processor (i.e. the processor 13, 23 or a dedicated arbiter as discussed above) may select the first filter A to electronically connect to the antenna module 122 and the communication device 121 for filtering the RF signals received from the antenna module 122 or the communication device 121.

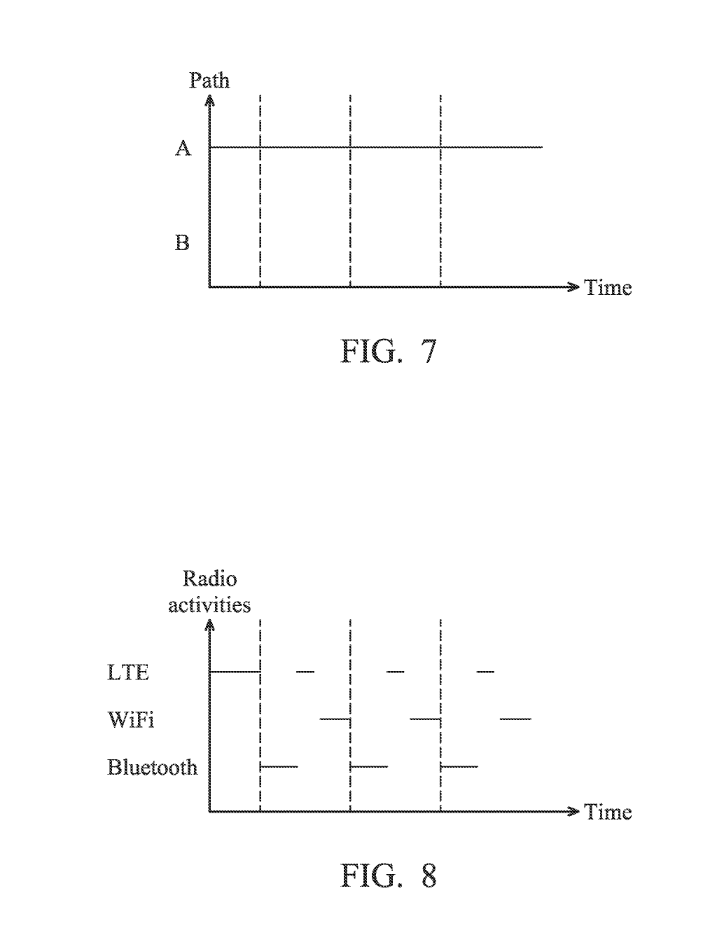

FIG. 7 is an exemplary timing diagram showing dynamic selections of different filtering paths according to an embodiment of the invention. As shown in FIG. 7, the filtering path is kept to path A. FIG. 8 is an exemplary timing diagram showing the scheduling of radio activities according to an embodiment of the invention, wherein the radio activities shown from the top row to the bottom row are the LTE, WiFi and Bluetooth radio activities, respectively. As shown in FIG. 8, the LTE, WiFi and Bluetooth radio activities are scheduled in the TDM manner to avoid interference. Note that the embodiments as illustrated above can all be applied for the case when the wireless module 120 is not a combo module and supports only one RAT communication. Those who are skilled in this technology can easily derive the filter path selection results by directly omitting one of the WiFi and Bluetooth radio activities in the embodiments as illustrated above.

Note that for the embodiments when the wireless module 120 is a WiFi and Bluetooth combo module capable of supporting 2.4 GHz and 5 GHz WiFi communication services, the WiFi and Bluetooth radio activities may be scheduled in the TDM manner to avoid interference, the WiFi and LTE radio activities may be scheduled in the FDM manner, and the Bluetooth and LTE radio activities may be scheduled in either TDM or FDM manner just like the designing concepts described above according to the radio frequencies utilized by the Bluetooth and LTE.

In addition, in some embodiments of the invention, before selecting the filter, the processor (i.e. the processor 13, 23 or a dedicated arbiter as discussed above) may first determine whether the wireless module 120 supports a 20/40 MHz WiFi operation or only supports a 20 MHz WiFi operation. When the processor determines that the wireless module 120 only supports a 20 MHz WiFi operation, the processor selects the filters based on the algorithms as discussed above. When the processor determines that the wireless module 120 supports a 20/40 MHz WiFi operation, the processor may further determine whether a frequency range of a passband of at least one of the filters in the filter module 200 can fully cover a 40 MHz WiFi channel. If not, the processor may facilitate the wireless module 120 to notify surrounding WiFi communication devices that the communication apparatus 100 supports only a 20 MHz WiFi operation. After the notification, the wireless module 120 may operate in a 20 MHz mode and the processor may select the filters based on the algorithms as discussed above. On the other hand, when a frequency range of a passband of at least one of the filters in the filter module 200 can fully cover a 40 MHz WiFi channel, the wireless module 120 may operate in a 20 MHz mode or a 40 MHz mode and the processor may select the filters based on the algorithms as discussed above.

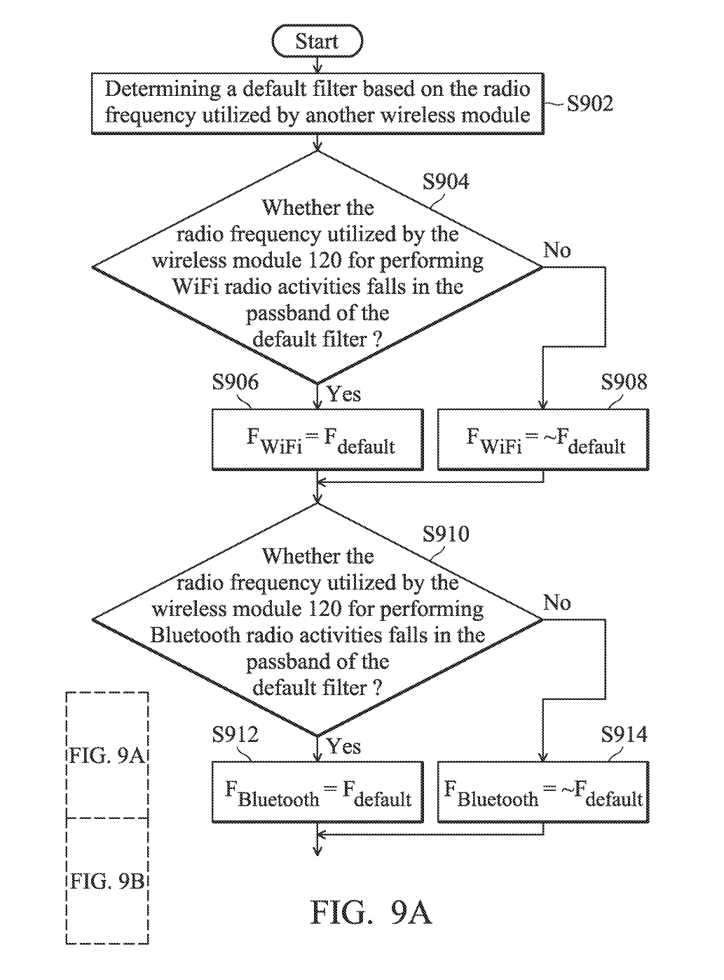

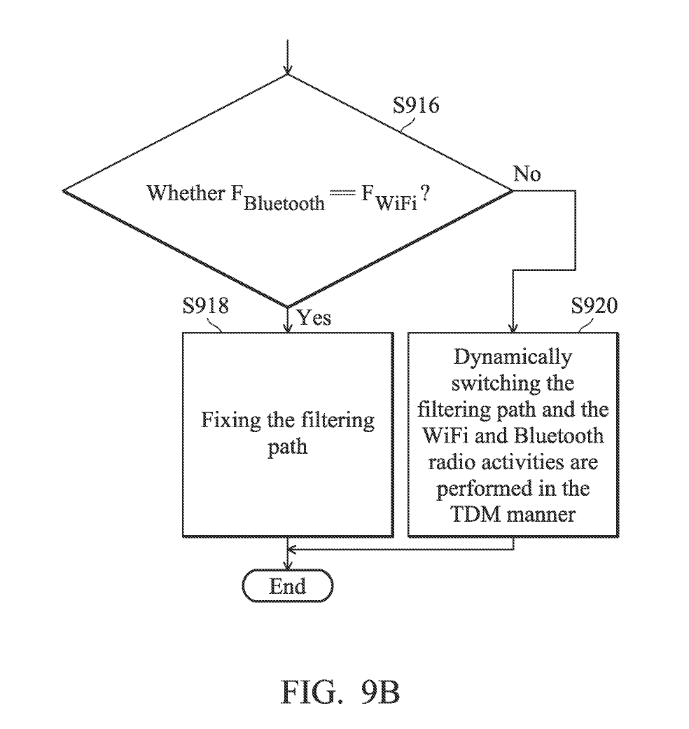

FIG. 9A and FIG. 9B show a flow chart of a method for dynamically selecting one of the filtering paths for the wireless module 120 according to an embodiment of the invention. First of all, the processor may determine a default filter based on the radio frequency utilized by another wireless module (for example, the wireless module 110) (Step S902). The value of a parameter F_{default} may be used to indicate the setting of the default filter. Next, the processor may determine whether the radio frequency utilized by the wireless module 120 for performing WiFi radio activities falls in the passband of the default filter (Step S904). If so, a WiFi filter is set to the default filter (Step S906). If not, the WiFi filter is not set to the default filter (Step S908). The value of a parameter F_{WiFi} may be used to indicate the setting of the WiFi filter and the symbol ‘˜’ represents NOT.

Next, the processor may determine whether the radio frequency utilized by the wireless module 120 for performing Bluetooth radio activities falls in the passband of the default filter (Step S910). If so, a Bluetooth filter is set to the default filter (Step S912). If not, the Bluetooth filter is not set to the default filter (Step S914). The value of a parameter F_{Bluetooth} may be used to indicate the setting of the Bluetooth filter. Next, the processor may further determine whether the Bluetooth filter and the WiFi filter are the same (Step S916). If so, the processor may fix the filtering path to a predetermined one (that is, the Bluetooth filter or the WiFi filter since they are the same) (Step S918) and the dynamically switching of filtering path is not required. If not, the processor may dynamically switch the filtering path for performing the WiFi and Bluetooth radio activities and the WiFi and Bluetooth radio activities are performed in the TDM manner (Step S920). Note that steps S910˜S914 may be performed before steps S904˜S908, or steps S910˜S914 and steps S904˜S908 may be performed in parallel, and the invention should not be limited thereto.

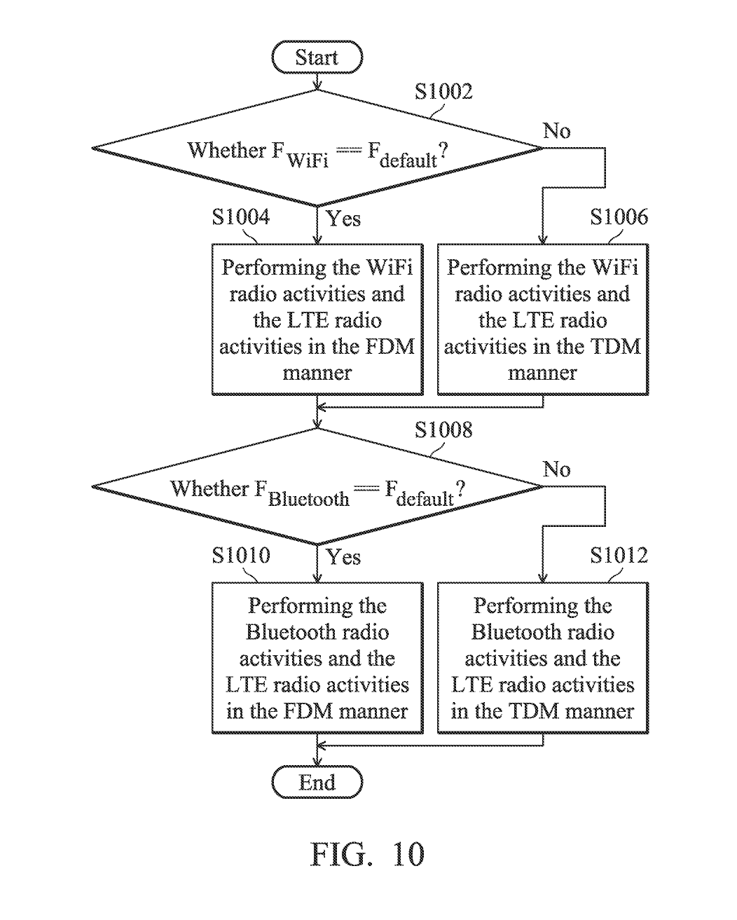

FIG. 10 shows a flow chart of a method for determining duplex mode between different wireless modules according to an embodiment of the invention. First of all, the processor may determine whether the WiFi filter is the same as the default filter (Step S1002). If so, the WiFi radio activities and the LTE radio activities may be scheduled and/or performed in the FDM manner (Step S1004). If not, the WiFi radio activities and the LTE radio activities are scheduled and/or performed in the TDM manner (Step S1006). Next, the processor may determine whether the Bluetooth filter is the same as the default filter (Step S1008). If so, the Bluetooth radio activities and the LTE radio activities may be scheduled and/or performed in the FDM manner (Step S1010). If not, the Bluetooth radio activities and the LTE radio activities are scheduled and/or performed in the TDM manner (Step S1012). Note that steps S1008˜S1012 may be performed before steps S1002˜S1006, or steps S1008˜S1012 and steps S1002˜S1006 may be performed in parallel, and the invention should not be limited thereto.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communication apparatus, comprising a first wireless module and a second wireless module, wherein the first wireless module comprises:
a communication device, comprising a processor, and capable of providing a first wireless communication service of a first radio access technology (RAT) in compliance with a first protocol;
an antenna module; and
a filter module, coupled between the communication device and the antenna module and comprising:
a first filter;
a second filter;
a first switch, switching in response to a control signal; and
a second switch, switching in response to the control signal,
wherein the processor issues the control signal according to a radio frequency utilized by the second wireless module to select the first filter or the second filter to electronically connect to the communication device and the antenna module.

2. The communication apparatus as claimed in claim 1, wherein when the radio frequency utilized by the second wireless module falls in a first frequency range of a first passband of the first filter, the processor selects the second filter.

3. The communication apparatus as claimed in claim 1, wherein a union of a first frequency range of a first passband of the first filter and a second frequency range of a second passband of the second filter covers a predetermined frequency range from 2.4 GHz to 2.5 GHz.

4. The communication apparatus as claimed in claim 3, wherein the first frequency range is located in a lower portion of the predetermined frequency range frequency range, and the first frequency range partially overlaps the second frequency range.

5. The communication apparatus as claimed in claim 3, wherein the first frequency range completely overlaps the second frequency range and is narrower than the second frequency range.

6. The communication apparatus as claimed in claim 1, wherein the processor issues the control signal to select the first filter or the second filter further according to a radio frequency utilized by the first wireless module.

7. The communication apparatus as claimed in claim 6, wherein when the radio frequency utilized by the second wireless module and the radio frequency utilized by the first wireless module both fall in a first frequency range of a first passband of the first filter, the processor selects the first filter.

8. The communication apparatus as claimed in claim 7, wherein radio activities of the first wireless module and radio activities of the second wireless module are performed in a time-division multiplex manner when the radio frequency utilized by the second wireless module and the radio frequency utilized by the first wireless module both fall in the first frequency range and the processor selects the first filter.

9. The communication apparatus as claimed in claim 7, wherein transmitting activities of the first and the second wireless modules and receiving activities of the first and second wireless modules are performed in a time-division multiplex manner when the radio frequency utilized by the second wireless module and the radio frequency utilized by the first wireless module both fall in the first frequency range and the processor selects the first filter.

10. A communication apparatus, comprising:
a first wireless module, capable of utilizing a first radio frequency to provide a first wireless communication service of a first radio access technology (RAT);
a second wireless module, capable of utilizing a second radio frequency to provide a second wireless communication service of a second RAT; and
a processor,
wherein the first wireless module comprises:
a communication device, providing the first wireless communication service of the first RAT in compliance with a first protocol;
an antenna module; and
a filter module, coupled between the communication device and the antenna module and comprising:
a first filter;
a second filter;
a first switch, switching in response to a control signal; and
a second switch, switching in response to the control signal,
wherein the processor issues the control signal to select the first filter or the second filter to electronically connect to the communication device and the antenna module according to the first radio frequency and the second radio frequency, and wherein a first frequency range of a first passband of the first filter overlaps a second frequency range of a second passband of the second filter.

11. The communication apparatus as claimed in claim 10, wherein radio activities of the first wireless module and radio activities of the second wireless module are performed in a time-division multiplex manner when the first radio frequency and the second radio frequency both fall in the first frequency range and the

12. The communication apparatus as claimed in claim 10, wherein transmitting activities of the first and the second wireless modules and receiving activities of the first and second wireless modules are performed in a time-division multiplex manner when the first radio frequency and the second radio frequency both fall in the first frequency range and the processor selects the first filter.

13. The communication apparatus as claimed in claim 10, wherein the first wireless module is further capable of utilizing a third radio frequency to provide a third wireless communication service of a third RAT, and wherein the processor dynamically selects the first filter or the second filter based on radio activities of the first RAT and the third RAT when the first radio frequency falls in the first frequency range and the third radio frequency fall in the second frequency range.

14. The communication apparatus as claimed in claim 13, wherein when the first radio frequency, the second radio frequency and the third radio frequency all fall in the first frequency range, the processor selects the first filter and the radio activities of the first wireless module and the radio activities of the second wireless module are performed in a time-division multiplex manner.

15. The communication apparatus as claimed in claim 10, wherein when the first radio frequency, the second radio frequency and the third radio frequency all fall in the first frequency range, the processor selects the first filter and the transmitting activities of the first and second wireless modules and the receiving activities of the first and second wireless modules are performed in a time-division multiplex manner.

16. The communication apparatus claimed in claim 10, wherein the processor
